(19) United States
(12) Patent Application Publication
(10) Pub. No.: US 2003/0224889 A1
(43) Pub. Date: Dec. 4, 2003

(54) Idle wheel adjustment assembly

(76) Inventor: Tai-Yang Luh, Tai Ping City (TW)

Correspondence Address: Alan D. Kamrath, Rider, Bennett, Egan & Arundel, LLP, Suite 200, 333 South Seventh Street, Minneapolis, MN, 55402, US

(21) Appl. No.: 10/162,490

(22) Filed: Jun. 3, 2002

(51) Int. Cl. F16H 7/08; F16H 7/12; F16H 7/14

(52) U.S. Cl. 474/134; 474/133; 474/138; 474/117; 474/101

(57) ABSTRACT

An idle wheel adjustment assembly has a generally L-shaped frame, a coiled spring, an oblong rocking frame, a first shaft pin, a first bearing, a first idle wheel, a second shaft pin, a second bearing, and a second idle wheel. The generally L-shaped frame has a through hole and an end column. The oblong rocking frame has a main shaft, an upper pillar, an upper circular hole, and a lower round hole. The first bearing is inserted in the first idle wheel. The second bearing is inserted in the second idle wheel. The first shaft pin is inserted through the upper circular hole and the first bearing. The second shaft pin is inserted through the lower round hole and the second bearing. The main shaft is inserted through the through hole. The coiled spring has a first hook end connected to the upper pillar and a second hook end connected to the end column.

### BACKGROUND OF THE INVENTION

The present invention relates to an idle wheel adjustment assembly. More particularly, the present invention relates to an idle wheel adjustment assembly for transmission chains.

U.S. patent application Ser. No. 09/650,209 has been filed by the same inventor on Aug. 29, 2000. U.S. patent application Ser. No. 09/650,209 has disclosed a transmission assembly having idle wheels. However, the idle wheels are useful in one rotating direction only. If the idle wheels are useful clockwise, the idle wheels will be useless counterclockwise. If the idle wheels are useful counterclockwise, the idle wheels will be useless clockwise.

### SUMMARY OF THE INVENTION

An object of the present invention is to provide an idle wheel adjustment assembly which are useful while rotating clockwise.

Another object of the present invention is to provide an idle wheel adjustment assembly which are useful while rotating counterclockwise.

Accordingly, an idle wheel adjustment assembly comprises a generally L-shaped frame, a coiled spring, an oblong rocking frame, a first shaft pin, a first bearing, a first idle wheel, a second shaft pin, a second bearing, and a second idle wheel. The coiled spring has a first hook end and a second hook end. The generally L-shaped frame has a through hole and an end column. The oblong rocking frame has a main shaft, an upper pillar, an upper circular hole, and a lower round hole. The first bearing is inserted in the first idle wheel. The second bearing is inserted in the second idle wheel. The first shaft pin is inserted through the upper circular hole of the oblong rocking frame and the first bearing. The second shaft pin is inserted through the lower round hole of the oblong rocking frame and the second bearing. The main shaft is inserted through the through hole of the generally L-shaped frame. The first hook end of the coiled spring is connected to the upper pillar of the oblong rocking frame. The second hook end of the coiled spring is connected to the end column of the generally L-shaped frame.

### BRIEF DESCRIPTION OF THE DRAWINGS

FIG. 1 is a perspective exploded view of a pair of idle wheel adjustment assemblies and a vehicle frame of a preferred embodiment in accordance with the present invention;

FIG. 2 is a partially elevational view of FIG. 1;

FIG. 3 is a partially enlarged view of an idle wheel adjustment assembly of a preferred embodiment in accordance with the present invention;

FIG. 4 is a perspective assembly view of an idle wheel adjustment assembly of a preferred embodiment in accordance with the present invention;

FIG. 5 is a perspective exploded view of an idle wheel adjustment assembly of a preferred embodiment in accordance with the present invention; and

FIG. 6 is a schematic view illustrating an operation of an idle wheel adjustment assembly of a preferred embodiment in accordance with the present invention.

### DETAILED DESCRIPTION OF THE INVENTION

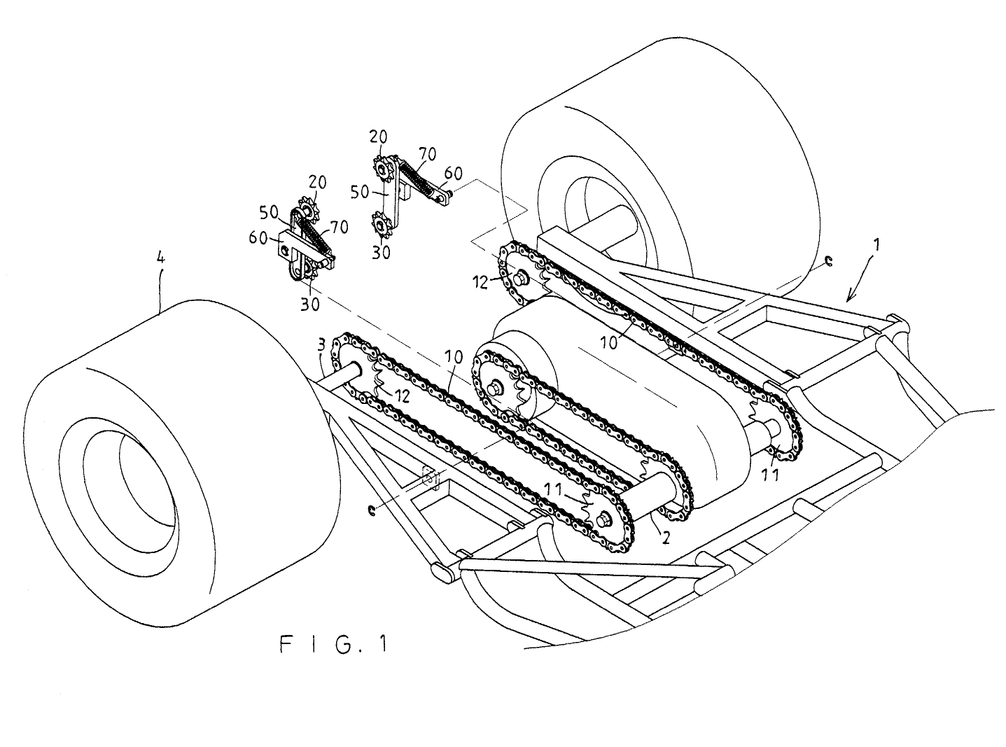

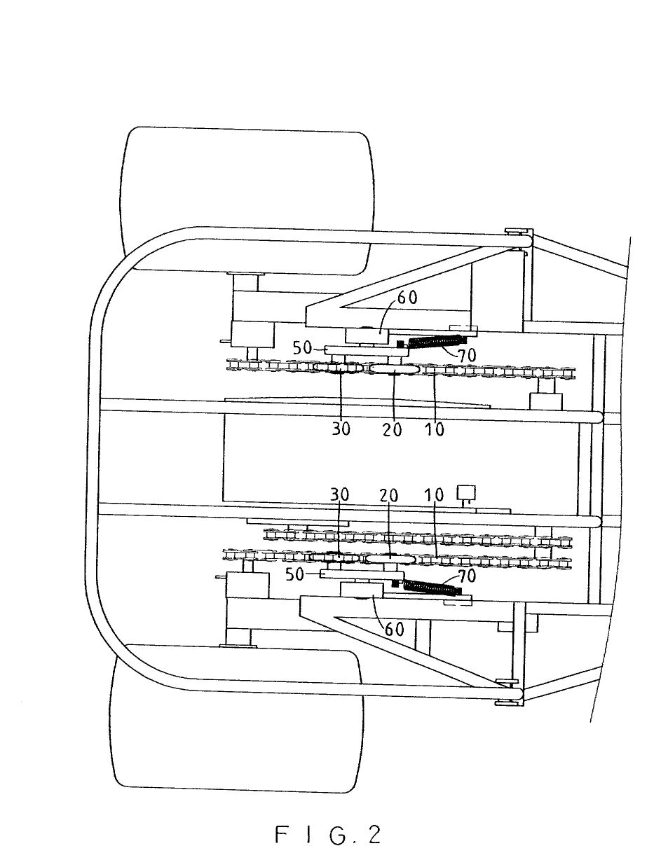

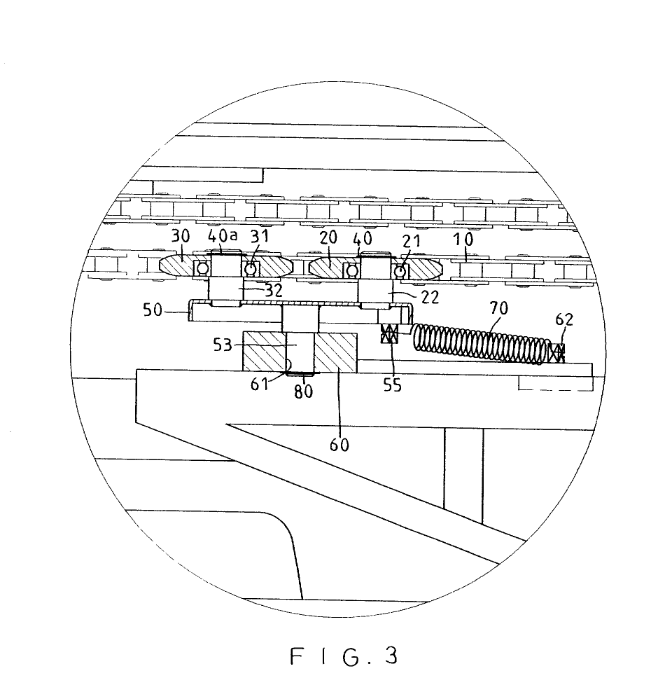

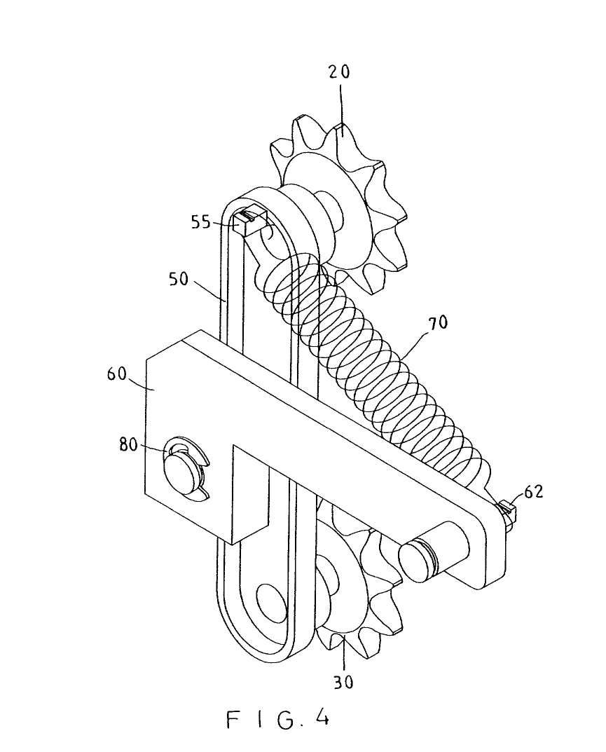

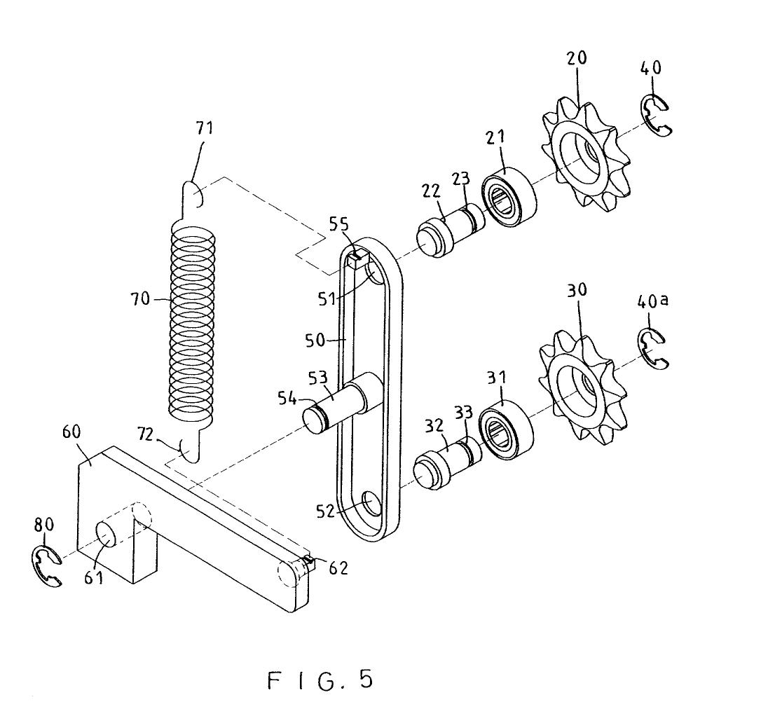

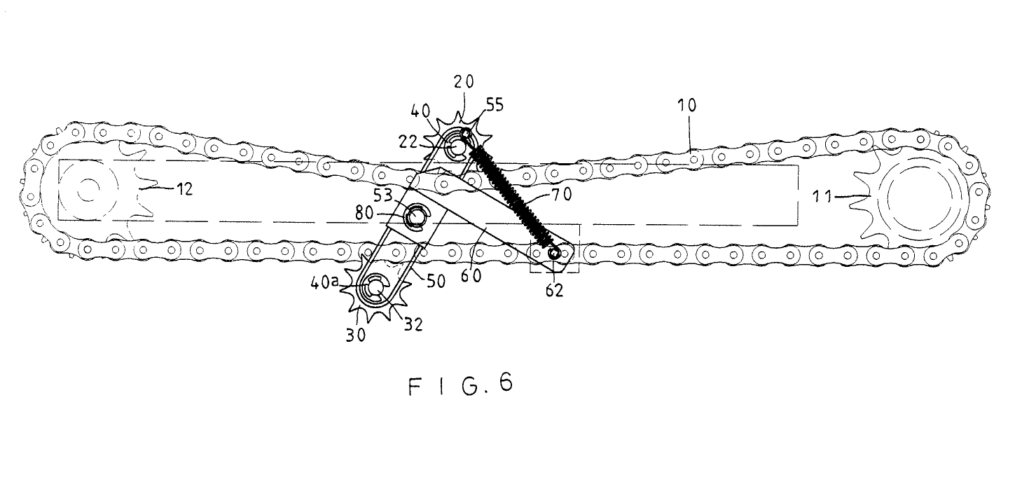

Referring to FIGS. 1 to 6, a vehicle frame 1 has a transmission shaft 2, a pair of wheel shafts 3, a pair of wheels 4, a pair of main gears 11, a pair of drive gears 12, and a pair of transmission chains 10.

The main gears 11 are disposed on the transmission shaft 2.

Each wheel shaft 3 is connected to the corresponding wheel 4 and the corresponding drive gear 12.

Each transmission chain 10 surrounds the corresponding main gear 11 and the corresponding drive gear 12.

A pair of idle wheel adjustment assemblies are disposed on the vehicle frame 1.

Each idle wheel adjustment assembly engages with the corresponding transmission chain 10.

Each idle wheel adjustment assembly comprises a generally L-shaped frame 60, a coiled spring 70, an oblong rocking frame 50, a first shaft pin 22, a first bearing 21, a first idle wheel 20, a first generally C-shaped retainer 40, a second shaft pin 32, a second bearing 31, a second idle wheel 30, a second generally C-shaped retainer 40a, and a third generally C-shaped retainer 80.

The coiled spring 70 has a first hook end 71 and a second hook end 72.

The generally L-shaped frame 60 has a through hole 61 and an end column 62.

The oblong rocking frame 50 has a main shaft 53, an upper pillar 55, an upper circular hole 51, and a lower round hole 52.

The first bearing 21 is inserted in the first idle wheel 20.

The second bearing 31 is inserted in the second idle wheel 30.

The first shaft pin 22 is inserted through the upper circular hole 51 of the oblong rocking frame 50 and the first bearing 21.

The second shaft pin 32 is inserted through the lower round hole 52 of the oblong rocking frame 50 and the second bearing 31.

The main shaft 53 is inserted through the through hole 61 of the generally L-shaped frame 60.

The first hook end 71 of the coiled spring 70 is connected to the upper pillar 55 of the oblong rocking frame 50.

The second hook end 72 of the coiled spring 70 is connected to the end column 62 of the generally L-shaped frame 60.

The first shaft pin 22 has a first annular groove 23 to receive the first generally C-shaped retainer 40.

The second shaft pin 32 has a second annular groove 33 to receive the second generally C-shaped retainer 40a.

The main shaft 53 has an annular recess 54 to receive the third generally C-shaped retainer 80.

The first idle wheel 20 and the second idle wheel 30 engage with the corresponding transmission chain 10.

The first idle wheel 20 and the second idle wheel 30 are useful while rotating clockwise.

The first idle wheel 20 and the second idle wheel 30 are useful while rotating counterclockwise.

The invention is not limited to the above embodiment but various modification thereof may be made. Further, various changes in form and detail may be made without departing from the scope of the invention.

I claim:

1. An idle wheel adjustment assembly comprises:
a generally L-shaped frame, a coiled spring, an oblong rocking frame, a first shaft pin, a first bearing, a first idle wheel, a second shaft pin, a second bearing, and a second idle wheel,
the coiled spring having a first hook end and a second hook end,
the generally L-shaped frame having a through hole and an end column,
the oblong rocking frame having a main shaft, an upper pillar, an upper circular hole, and a lower round hole,
the first bearing inserted in the first idle wheel,
the second bearing inserted in the second idle wheel,
the first shaft pin inserted through the upper circular hole of the oblong rocking frame and the first bearing,
the second shaft pin inserted through the lower round hole of the oblong rocking frame and the second bearing,
the main shaft inserted through the through hole of the generally L-shaped frame,
the first hook end of the coiled spring connected to the upper pillar of the oblong rocking frame, and
the second hook end of the coiled spring connected to the end column of the generally L-shaped frame.

2. The idle wheel adjustment assembly as claimed in claim 1, wherein the first shaft pin has a first annular groove to receive a first generally C-shaped retainer.

3. The idle wheel adjustment assembly as claimed in claim 1, wherein the second shaft pin has a second annular groove to receive the second generally C-shaped retainer.

4. The idle wheel adjustment assembly as claimed in claim 1, wherein the main shaft has an annular recess to receive the third generally C-shaped retainer.
